(19) United States
(12) Patent Application Publication
(10) Pub. No.: US 2026/0178004 A1
(43) Pub. Date: Jun. 25, 2026

(54) NETWORKING SYSTEM BASED ON EMBEDDED DATA ACQUISITION WORKSTATIONS

(71) Applicant: Fujian Shunchang Hongrun Precision Instrument Co., Ltd., Fujian Province (CN)

(72) Inventors: Shanping LIN, Fujian Province (CN); Honghao LIN, Fujian Province (CN); Zhuorui PAN, Fujian Province (CN); Xiangjun LIN, Fujian Province (CN)

(21) Appl. No.: 19/325,489

(22) Filed: Sep. 11, 2025

(30) Foreign Application Priority Data
Dec. 19, 2024 (CN) 202411876198.X

(51) Int. Cl. G05B 19/042

(52) U.S. Cl. CPC G05B 19/0423; G05B 19/0421; G05B 2219/21104; G05B 2219/21129; G05B 2219/2231; G05B 2219/24215; G05B 2219/25092; G05B 2219/25166; G05B 2219/25171; G05B 2219/25174; G05B 2219/25176; G05B 2219/25179; G05B 2219/25345

(57) ABSTRACT

A networking system based on a plurality of embedded data acquisition workstations each having a core board and an acquisition board in communication with other. The core board uses an embedded LINUX® operating system. The networking system also includes a computer, and it adopts a tree topology structure with at least three layers. A root node of the networking system is the computer, and all other nodes apart from the root node are the embedded data acquisition workstations. At least one of the embedded data acquisition workstations serves simultaneously as a master station and a slave station to achieve network bridging function, such that communication between the embedded data acquisition workstations is no longer limited by the number of communication interfaces of the computer, acquisition channels are expanded, and the limitations caused by different communication protocols is resolved so that more application requirements can be met.

### TECHNICAL FIELD

The present invention relates to the technical field of automated data processing, and in particular, to a networking system based on embedded data acquisition workstations.

### BACKGROUND OF THE INVENTION

At present, a data acquisition workstation, also known as a paperless recorder, is used for collecting and recording various sensor signals during industrial production processes, and can also perform some standard pre-programmed controls, such as alarm control, PID control, logic control, etc. The Data acquisition workstation is characterized by a simple structure that records historical production data through internally installed recording chips, and can also back up and transfer historical data at regular intervals by inserting SD cards or USB drives via external interfaces.

With the continuous development of paperless recorders, various new types of paperless recorders have emerged on the basis of earlier old paperless recorders. However, the basic architecture of paperless recorders has never been fundamentally changed. Due to hardware limitations, existing paperless recorders have the following disadvantages:
1. Limited analog and digital channels, and the lack of extendibility;
2. The capacity for storing historical data is limited, and data stored locally in a paperless recorder can only be accessed via serial communication or Ethernet within a local network. Real-time access from external networks is not possible;
3. Although customized displays can be configured into a master computer and then programmed into the paperless recorder via a data interface so that the customized displays can be shown, it can only be achieved through the built-in channels of the paperless recorder. Extended channels do not support this functionality and can only modify the displays based on values obtained from the acquisition channels of the paperless recorder and cannot display complex menus or interfaces involving mathematical calculation results, intermediate variable values, and timing values etc;
4. When networking, the paperless recorder can only be accessed as a slave device; its communication protocol only supports the one preset at the factory, with very limited compatibility. The networking structures that can be supported are too simple, making it difficult to develop extended multifunctional applications.
BRIEF SUMMARY OF THE INVENTION

It is an object of the present invention to provide a networking system based on embedded data acquisition workstations.

The present invention provides the following technical solutions:
A networking system based on embedded data acquisition workstations, comprising a plurality of said embedded data acquisition workstations and a computer, wherein each of the embedded data acquisition workstations comprises a core board and an acquisition board connected electrically; the core board adopts an embedded LINUX® operating system; the networking system has a tree topology with at least three layers, where a root node of the tree topology is the computer, and all other nodes of the tree topology apart from the root node are the embedded data acquisition workstations; the embedded LINUX® operating system of each of the embedded data acquisition workstations is installed with a configuration software; a project file executable by the configuration software is imported into each of the embedded data acquisition workstations; the embedded data acquisition workstations form at least one parent-child node relationship wherein the project file of a parent node is written with communication protocols of corresponding child nodes thereof.

Preferably, the networking system based on embedded data acquisition workstations of the present invention adopts a three-layer tree topology. Considering the ability of data penetration through layers and to avoid data transmission congestion that may affect data transmission efficiency or even data loss, said three-layer tree topology is preferred.

Preferably, the project file of each of the embedded data acquisition workstations further comprises a customized interface. After configuring the customized interface, the customized interface and a native interface coexist, and the two interfaces can be switched by pressing a button or sliding up and down on a touchscreen. The customized interface not only enriches human-machine interaction interfaces, but also enables the displays of the embedded data acquisition workstation to fit better with the application in use by flexibly configuring the customized interface on the embedded LINUX® operating system according to a particular application scenario, thereby improving the suitability of the customized interface of the embedded data acquisition workstation with the particular application scenario, greatly improving the interface friendliness of the embedded data acquisition workstation, making its use more comfortable and convenient.

Preferably, the embedded LINUX® operating system of each of the embedded data acquisition workstations has database software downloaded and installed. In addition to local storage by a local memory, the embedded LINUX® operating system also supports the installation of database software to connect to external hardware such as solid-state drives and SD cards. As such, not only can the data inside the embedded data acquisition workstation be stored in the external hardware such as the solid-state drives and the SD cards to extend data storage, but also the data from external databases can be imported into the embedded data acquisition workstation through said external hardware. The imported data not only contains historical data stored in the database of other devices, but can also be parameters supporting the customized interface and menu of the embedded data acquisition workstation, and may even be control strategies, PLC point tables, program codes, functions, recipes, etc. In this way, the flexibility and friendliness of the application of the embedded data acquisition workstation are greatly improved.

Preferably, each of the embedded data acquisition workstations of the present invention further comprises a screen backplane, a power board, a transmitter board, a digital input board, and an alarm board, and each of which is electrically connected to the core board. The screen backplane, configured for screen control, is electrically connected to a display screen of the embedded data acquisition workstation; the power board is configured to provide DC power to the core board, the acquisition board, the screen backplane, the power board, the transmitter board, the digital input board, and the alarm board; the transmitter board is configured to output analog signals; the digital input board is configured to input digital signals; the alarm board is configured to control output of an alarm device. In addition to the screen backplane and the power board, each embedded data acquisition workstation of the present invention further comprises the transmitter board, the digital input board, and the alarm board, wherein the transmitter board is configured to output acquired values as analog signals, such as to other acquisition modules for remote synchronous display. Said other acquisition modules can be PLC, DCS acquisition systems, or other display devices. The digital input board facilitates the acquisition of some status signals, such as whether external valves are open or closed, whether external devices are alarming, and whether external buttons are pressed. The alarm board conveniently meets the need to trigger an alarm during monitoring of acquired data, for example, during water quality monitoring, when the monitored data reaches a preset value, an external alarm device can be connected via the alarm board 7 to trigger an alarm. By providing the transmitter board, the digital input board, and the alarm board, the functionality of the embedded data acquisition workstation is greatly enriched, enabling the embedded data acquisition workstation to meet more application requirements, and the functions of remote synchronous display with other acquisition modules, interlocking with external devices, and alarming function basically cover the needs of industrial productions, thus rendering the embedded data acquisition workstation to have a wide range of functions and higher use value.

Preferably, each of the embedded data acquisition workstations of the present invention further comprises a common board. The acquisition board, the power board, the transmitter board, the digital input board, and the alarm board are electrically connected to the core board via the common board. The common board serves as a bridge of connection between the core board and the acquisition board, the power board, the transmitter board, the digital input board, and the alarm board, so that interfaces of the core board, the acquisition board, the power board, the transmitter board, the digital input board, and the alarm board are all connected to the common board. Through the bridging function of the common board, the common board, the acquisition board, the power board, the transmitter board, the digital input board, and the alarm board are electrically connected to the core board. The common board facilitates a layout of installing the core board, the acquisition board, the screen backplane, the power board, the transmitter board, the digital input board, and the alarm board. The common board is provided with interfaces connectible to the acquisition board, the power board, the transmitter board, the digital input board, and the alarm board. When the acquisition board, the power board, the transmitter board, the digital input board, and the alarm board are connected to the common board which is in turns connected to the core board, connections are made through corresponding interfaces.

Preferably, each of the embedded data acquisition workstations of the present invention further comprises a USB interface and a TF card slot, both electrically connected to the core board, and both soldered onto the screen backplane. The USB interface is configured to connect an external USB drive for data export and transfer, and can also be multiplexed with an external keyboard and a mouse; after inserting a TF card into the TF card slot, the TF card expands the storage capacity of the data storage area. The USB interface and the TF card slot in the present invention enriches the functions of the embedded data acquisition workstation in terms of data export, transfer, and extension of storage capacity, so that the embedded data acquisition workstation can meet more application requirements. After the USB interface and the TF card slot are soldered onto the screen backplane, and the embedded data acquisition workstation is assembled as a meter device, it is convenient to externally expose the USB interface and the TF card slot.

Preferably, each of the embedded data acquisition workstations of the present invention further comprises a SIM sub-board, a 4G board, a WIFI® board, an RS232 communication interface, an RS485 communication interface, an Ethernet interface, an Ethernet chip, an RS485 communication circuit, and a printer communication circuit; the SIM sub-board, the 4G board, the WIFI® board, the RS232 communication interface, the RS485 communication interface, and the Ethernet interface are arranged on the power board; the Ethernet chip is soldered onto the screen backplane; the RS485 communication circuit and the printer communication circuit are arranged on the common board; the SIM sub-board, the 4G board, and the core board are electrically connected in sequence; the WIFI® board is electrically connected to the core board; the RS232 communication interface, the printer communication circuit, and the core board are electrically connected in sequence; the RS485 communication interface, the RS485 communication circuit, and the core board are electrically connected in sequence; the Ethernet interface, the Ethernet chip, and the core board are electrically connected in sequence. The SIM sub-board is vertically soldered and fixed perpendicularly on the power board, and the SIM sub-board comprises, but not limited to, a SIM card slot and a control circuit, and connects with the 4G board via an I²C bus to exchange data. The 4G board comprises, but not limited to, a 4G module and an external antenna. The 4G board may be installed on the power board in parallel with the power board via, but not limited to, pin headers and sockets, and is connected to the core board via USB serial bus through the common board. A function of the 4G board is to realize wireless data transmission with computers and other peripherals via CDMA or GPRS wireless network of a SIM card. The WIFI® board comprises, but not limited to, an onboard RTL8723 chip and its peripheral circuit, and can switch communication networks between WIFI® 2.4G and Bluetooth® 5.0; wherein, WIFI® uses SDIO interface, and Bluetooth® uses the USB serial bus; internally speaking, the WIFI® board connects to the core board via the common board to transmit data, and externally speaking, the WIFI® board connects with external devices via WIFI® 2.4G and Bluetooth® pairing. The RS232 communication interface and the RS485 communication interface are two other communication output interfaces, wherein the RS485 communication interface 45 can use a two-wire RS485 communication line to achieve networking with external devices, realizing network communication among multiple devices within a range of around one kilometer, and the protocol adopted can be a MODBUS-RTU standard protocol. The RS232 communication interface is configured as an external micro-printer which receives parallel data to achieve scheduled or real-time printing of acquired data for users to review. The Ethernet chip is configured to decode Ethernet communication data of the core board. The Ethernet chip is but not limited to a RTL8211F PHY chip. The Ethernet interface mainly comprises a HR911130 socket, which mainly comprises an RJ45 interface and an Ethernet transformer. During operation, the Ethernet communication data of the core board is decoded into digital differential signals by the Ethernet chip located on the screen backplane, and then the digital differential signals are transmitted to the Ethernet interface on the power board through the common board, and then being coupled by using the Ethernet transformer integrated in the Ethernet interface, and finally being transmitted to external network cables of different levels through the RJ45 interface integrated in the Ethernet interface. The embedded data acquisition workstations of the present invention support various communication methods such as 4G, WIFI®, Bluetooth®, serial port, Ethernet, etc., to meet various communication needs of users, with better convenience in use. In the present invention, various chips and interfaces are arranged reasonably and connected conveniently.

Preferably, the core board comprises a core processor, a power management chip, and a memory unit; the power management chip and the memory unit are electrically connected to the core processor; the acquisition board comprises an acquisition circuit, an acquisition processor, and an acquisition board memory; the acquisition circuit and the acquisition board memory are electrically connected to the acquisition processor; the power board comprises an on/off power circuit which is electrically connected to the power management chip; the transmitter board comprises a transmitter output processor, an active low-pass filter circuit, an integrating circuit, and a transmitter board memory; the transmitter board memory is electrically connected to the transmitter output processor; the transmitter output processor, the integrating circuit, and the active low-pass filter circuit are electrically connected in sequence; the digital input board comprises a digital acquisition processor and a Direct-Input (DI) sampling circuit electrically connected with each other; the alarm board comprises an alarm processor and an alarm control circuit electrically connected with each other; the acquisition processor, the screen backplane, the transmitter output processor, the digital acquisition processor, and the alarm processor are electrically connected to the core processor. The core processor is, but not limited to, an ARM Cortex-A55 processor; the power management chip is, but not limited to, an RK809 power management chip, and the memory unit comprises, but not limited to, a DDR4 memory and an EMMC storage controller, wherein the DDR4 memory has a storage capacity of at least 2 GB and expandable up to 8 GB, and the EMMC storage controller comprises an 8 GB EMMC program storage area and an 8 GB EMMC data storage area. Additionally, SSD hard drives can be expanded via PCIe M.2 interfaces, and TF cards can be expanded via more of said TF card slot, thus further expanding a capacity of the data storage area. The acquisition board and the core board exchange data via a serial bus. The acquisition circuit can acquire analog signals such as mA, mV, V, thermal resistance, and thermocouple, and a single acquisition board can simultaneously acquire up to eight analog signals. According to user's requirements of different functions, more than one acquisition board can be provided. The acquisition board memory is configured to store calibration values of sampled signals, and can be, for example, an I²C bus 24C04 memory. After the on/off power circuit is electrically connected to the power management chip, the on/off power circuit supplies power to various circuit boards via the power management chip. The transmitter board and the core board exchange data via a serial bus. The transmitter board uses a PWM port of the transmitter output processor to modulate its duty cycle to generate a pulse signal, which is sent to the active low-pass filter circuit after being processed by the integrating circuit. At an output end of the active low-pass filter circuit, analog output signals that vary linearly with respect to a PWM duty cycle signal modulated by the transmitter output processor are obtained. The analog output signals mainly comprise 0-20 mA, 4-20 mA, 0-5V, and 1-5V. The transmitter board memory may be, for example, an I²C bus 24C04 memory connected to the transmitter output processor for storing calibration parameters of transmitter output. The digital input board and the core board exchange data via a serial bus. A single digital input board can simultaneously acquire up to twelve channels of DI signals, and all DI acquisition is subject to isolation based on optoelectronic coupling to reduce interference. The alarm board and the core board exchange data via a serial bus. During operation, the alarm processor controls the alarm control circuit to send alarm signals through a PWM interface. At least twelve alarm control circuits can be configured on the alarm board according to user's needs.

Preferably, the core board is mounted on the screen backplane; the common board is arranged parallel and stacked with the screen backplane; the acquisition board, the power board, the transmitter board, the digital input board, and the alarm board are all located on a side of the common board away from the screen backplane; the acquisition board, the power board, the transmitter board, the digital input board, and the alarm board are arranged in parallel and stacked with one another; the acquisition board is oriented perpendicular to the common board. This structural arrangement not only facilitates assembly, but also facilitates external arrangement of different interfaces. For example, the USB interface and the TF card slot can be placed at one side of the screen backplane, while the SIM sub-board, the RS232 communication interface, the RS485 communication interface, and the Ethernet interface can be placed at a rear part of the embedded data acquisition workstation away from the screen backplane.

In each embedded data acquisition workstation in which the embedded LINUX® operating system is installed in the core board on the basis of the hardware architecture of the core board, the embedded LINUX® operating system supports downloading and installation of database software which significantly expands data storage methods, enhances data storage capacity, provides both local data storage and connection with external network database/cloud platform access, enabling external data preservation. This ensures local real-time efficiency and security for data storage while also supporting multi-site backup and cross-platform viewing. On the other hand, the embedded LINUX® operating system supporting configuration software to be installed enables an application scenario of programming by a master computer and execution by a slave computer, allowing a project file capable of running on the configuration software be programmed and then be imported to the corresponding embedded data acquisition workstation at any time desired and run on the configuration software of the corresponding embedded data acquisition workstation, thereby flexibly adjusting the functionality of the embedded data acquisition workstation to meet various application requirements. For example, if communication protocols of other devices are written into the project file of a certain embedded data acquisition workstation, that certain embedded data acquisition workstation can act as a master station, communicate with other devices, and thus expand its data acquisition. Particularly, in an application scenario involving a kind of digital sensor in the prior art which is significantly limited in use due to it adaptability only to a specifically designated data reader, the embedded data acquisition workstation of the present invention communicates with such data reader to read and collect data from the digital sensor, thereby greatly increasing the types of data that can be collected and providing a larger number and more flexible options for users. Similarly, a customized interface can be written into a project file according to a specific application scenario, so that after running the project file in the configuration software of the corresponding embedded data acquisition workstation, the customized interface can be displayed on the embedded data acquisition workstation. Moreover, both local collection channels and external extended channels can be configured into the same customized interface in conjunction with the enriched protocol interfaces and configuration of the customized interface to allow users to create their own products. This greatly enhances the flexibility and user-friendliness during use.

In the networking system based on embedded data acquisition workstations of the present invention, under the network bridging of the embedded data acquisition workstations that can act as both master devices and slave devices, communication between the embedded data acquisition workstations is no longer limited by a number of communication interfaces of the computer, thereby greatly enhancing the extendibility of data acquisition channels. On the other hand, even if the communication protocols of the embedded data acquisition workstations and the communication protocol of the computer are inconsistent, indirect communication can still be achieved through interfacing by the network bridging, thereby effectively solving the problem of limitations caused by different communication protocols, and hence making the embedded data acquisition workstations more flexible and adaptable to the needs of different applications.

### BRIEF DESCRIPTION OF THE DRAWINGS

FIG. 1 is a structural diagram of the networking system based on embedded data acquisition workstations according to the present invention.

FIG. 2 is a functional block diagram of an embedded data acquisition workstation according to the present invention.

FIG. 3 is a structural assembling diagram of the embedded data acquisition workstation according to the present invention.

### DETAILED DESCRIPTION OF THE INVENTION

The preferred embodiments of the networking system based on embedded data acquisition workstations according to the present invention are described in detail below in conjunction with the drawings:

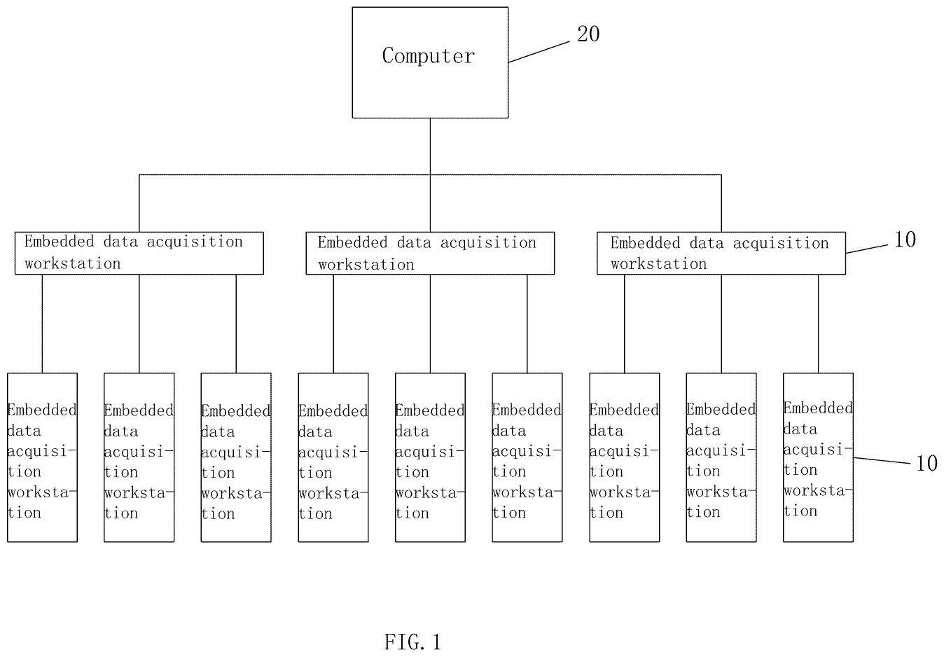

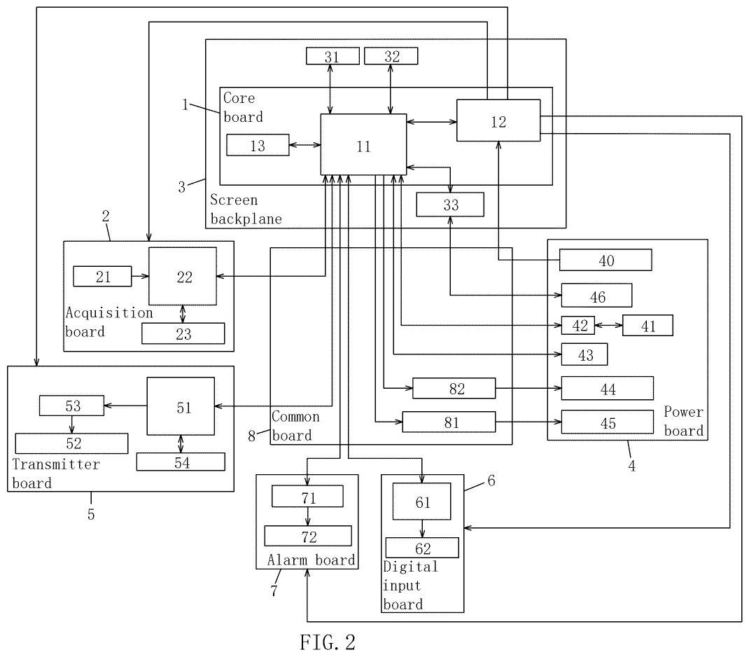

As shown in FIGS. 1 and 2, a networking system based on embedded data acquisition workstations, wherein each of the embedded data acquisition workstations comprises a core board 1 and an acquisition board 2 connected electrically, wherein the core board 1 adopts an embedded LINUX® operating system. The networking system comprises a plurality of embedded data acquisition workstations 10 and a computer 20. The networking system has a tree topology with at least three layers, where a root node of the tree topology is the computer 20, and all other nodes except for the root node are the embedded data acquisition workstations 10. The embedded LINUX® operating system of each of the embedded data acquisition workstations 10 is installed with a configuration software; project file that can run on the configuration software are imported into each of the embedded data acquisition workstations 10. The embedded data acquisition workstations 10 form at least one parent-child node relationship wherein the project file of a parent node is written with communication protocols of corresponding child nodes thereof.

In each of the embedded data acquisition workstations 10 of the present invention, the core board 1 is a circuit board integrated with a microprocessor, a memory, and a plurality of interface circuits, and serves as a core component of the corresponding embedded data acquisition workstation. The acquisition board 2 is configured to be connected to sensors for signal acquisition. In terms of hardware architecture, the core board 1 adopts an embedded LINUX® operating system, whose open source, small kernel, and high efficiency can meet various requirements in designing various application layers.

The embedded LINUX® operating system of the core board 1 can support the installation of various software as desired on the basis of the hardware architecture of the core board 1 so as to meet different needs of applications. The embedded LINUX® operating system of the core board 1 also supports downloading and installation of database software, so as to connect external hardware such as solid-state drives (SSD) and SD cards. For example, configuration software can be installed in the embedded LINUX® operating system of the core board 1. With the configuration software installed, project file that can run on the configuration software can be created on the computer first, and then being imported into the corresponding embedded data acquisition workstation to enable different functions written on the project file. For instance, if a project file of a certain embedded data acquisition workstation is written with communication protocols of other embedded data acquisition workstations, the project file, after being run on the configuration software of that certain embedded data acquisition workstation, enables that certain embedded data acquisition workstation to communicate with other embedded data acquisition workstations; in other words, said certain embedded data acquisition workstation becomes a master device that initiates communication requests and communicates with the other embedded data acquisition workstations. Similarly, a customized interface can be written into a project file according to a particular application scenario, so that after running the project file in the configuration software of the corresponding embedded data acquisition workstation, the customized interface can be displayed.

In each embedded data acquisition workstation in which the embedded LINUX® operating system is installed in the core board 1 on the basis of the hardware architecture of the core board 1, the embedded LINUX® operating system supports downloading and installation of database software significantly expands data storage methods, enhances data storage capacity, provides both local data storage and connection with external network database/cloud platform access, enabling external data preservation. This ensures local real-time efficiency and security for data storage while also supporting multi-site backup and cross-platform viewing. On the other hand, the embedded LINUX® operating system supporting configuration software to be installed enables an application scenario of programming by a master computer and execution by a slave computer, allowing project file capable of running on the configuration software be programmed and then be imported to the corresponding embedded data acquisition workstation at any time desired and run on the configuration software of the corresponding embedded data acquisition workstation, thereby flexibly adjusting the functionality of the embedded data acquisition workstation to meet various application requirements. For example, if communication protocols of other devices are written into the project file of a certain embedded data acquisition workstation, that certain embedded data acquisition workstation can act as a master station, communicate with other devices, and thus expand its data acquisition. Particularly, in an application scenario involving a kind of digital sensor in the prior art which is significantly limited in use due to it adaptability only to a specifically designated data reader, the embedded data acquisition workstation of the present invention communicates with such data reader to read and collect data from the digital sensor, thereby greatly increasing the types of data that can be collected and providing a larger number and more flexible options for users. Similarly, a customized interface can be written into a project file according to a specific application scenario, so that after running the project file in the configuration software of the corresponding embedded data acquisition workstation, the customized interface can be displayed on the embedded data acquisition workstation. Moreover, both local collection channels and external extended channels can be configured into the same customized interface in conjunction with the enriched protocol interfaces and configuration of the customized interface to allow users to create their own products. This greatly enhances the flexibility and user-friendliness during use.

The embedded data acquisition workstation of the present invention utilizes the hardware architecture of the core board 1 and the embedded LINUX® operating system to provide user's customization. In networking, each embedded data acquisition workstation can serve as both a master device and a slave device. When networking with the computer 20, the embedded data acquisition workstations of the present invention can form a networking system with a tree topology of three or more layers, where the computer 20 is the root node and all other nodes are said embedded data acquisition workstations 10. Given a parent-child relationship between the computer 20 and a certain embedded data acquisition workstation 10, the computer 20 acts as the master device, and that certain embedded data acquisition workstation 10 acts as the slave device. Given a parent-child relationship between two embedded data acquisition workstations 10, and a project file of the parent node comprises a communication protocol of the child node, communication between the two embedded data acquisition workstations 10 can be established via Ethernet or RS485 as hardware communication interfaces, with one of the embedded data acquisition workstations being the parent node acting as the master device and another one of the embedded data acquisition workstations being the child node acting as the slave device, thereby establishing a data link for data exchange.

In the networking system comprising the embedded data acquisition workstations 10 and the computer 20, after connecting a terminal of the acquisition board 2 of each of the embedded data acquisition workstations 10 to signals of a respective sensor, each of the embedded data acquisition workstations 10 can independently collect, record, and display data locally. Moreover, under network bridging by at least one of the embedded data acquisition workstations 10 located in at least one intermediate layer of the tree topology, data acquired by the embedded data acquisition workstations 10 at various layers can be transmitted upward layer by layer. Specifically, data acquired by each of the embedded data acquisition workstations 10 is first stored in its own local data storage area, and upon communication of one of the embedded data acquisition workstations at a lower layer with another one of the embedded data acquisition workstations at an upper layer, the data of said one of the embedded data acquisition workstations is read by and stored into a local data storage area of said another one of the embedded data acquisition workstations at the upper layer; said another one of the embedded data acquisition workstations at the upper layer can read and display data acquired by its own local data storage area and also regulate, read, and display the data uploaded and stored into its own local data storage area from said one of the embedded data acquisition workstations from the lower layer. When said another one of the embedded data acquisition workstations at the upper layer displays data collected from said one of the embedded data acquisition workstations at the lower layer, since the data collected from said one of the embedded data acquisition workstations at the lower layer is already stored in said another one of the embedded data acquisition workstations at the upper layer, said another one of the embedded data acquisition workstations at the upper layer only needs to fetch the data from its own data storage area for display, without the need to communicate with said one of the embedded data acquisition workstations at the lower layer for uploading data, thereby resulting in higher data processing efficiency.

A conventional paperless recorder can only act as a slave device in a network with a computer, supporting only a single rigid master-slave structure where the computer is the master device and the paperless recorder is the slave device, and the master device and the slave device are communicated only via a single bus such as RS485 or Ethernet. There is no data exchange between different paperless recorders. The present invention, by forming a networking system of a tree topology having three or more layers comprising the embedded data acquisition workstations 10 and the computer 20, breaks through the technical bottleneck of the prior art single rigid master-slave structure, enables both master-slave interactions between the computer 20 and the embedded data acquisition workstations 10 as well as master-slave interactions between at least two embedded data acquisition workstations 10. Under the network bridging of at least one embedded data acquisition workstation 10 located in at least one intermediate layer of the tree topology, the computer at the top layer can even access the embedded data acquisition workstations 10 at lower layers below said at least one intermediate layer, thereby enabling cross-bus communication and networking.

In the networking system based on embedded data acquisition workstations of the present invention, under the network bridging of the embedded data acquisition workstations that can act as both master devices and slave devices, communication between the embedded data acquisition workstations is no longer limited by a number of communication interfaces of the computer, thereby greatly enhancing the extendibility of data acquisition channels. On the other hand, even if the communication protocols of the embedded data acquisition workstations and the communication protocol of the computer 20 are inconsistent, indirect communication can still be achieved through interfacing by the network bridging, thereby effectively solving the problem of limitations caused by different communication protocols and enabling cross-bus communication networking, and hence making the embedded data acquisition workstations more flexible and adaptable to the needs of different applications.

The network system based on embedded data asquisition workstations of the present invention provides the following advantages:

### 1. Outstanding Protocol Compatibility

Seamless adaptation to multiple protocols: The networking system of the present invention has strong protocol compatibility. When any one of the embedded data acquisition workstations is to be connected to the networking system, simply import its communication protocol into a project file of a corresponding parent node to achieve seamless communication with the parent node. The networking system of the present invention does not impose any limitations on the type of protocol, so that the present invention is adaptable to different protocols, thereby greatly improving universality and flexibility.

Coexistence of different protocols to enable cross-brand support: Multiple child embedded data acquisition workstations connected to a same parent node may use different communication protocols, thus achieving compatibility of “one device, multiple protocols”. Accordingly, the networking system can easily integrate cross-brand devices, including special devices which may be foreign specialized meter readers, to realize data exchange, thoroughly solving the problems of rigid protocol requirements and poor device adaptability in conventional networking systems.

### 2. Powerful Acquisition Extendibility

Rich interfaces and communication extendibility: The embedded data acquisition workstation of each node is equipped with abundant local interfaces for direct data acquisition, and also supports acquisition of data from other devices by way of communication with said other devices, thereby greatly enhancing acquisition scope and capability.

Multi-level flexible extension architecture: The networking system of the present invention adopts a tree topology of three or more layers, allowing at least one node to connect to additional devices, enabling the networking system to extend its data acquisition flexibly to meet large-scale, complex industrial data acquisition needs.

Free protocol switching for enhanced acquisition capability: Since communication protocols are not restricted, the networking system of the present invention can flexibly choose and adapt to different protocols as needed during external data acquisition, thus further improving acquisition extendibility.

### 3. Excellent Flexibility

Efficient direct communication and data integration: Two embedded data acquisition workstations can communicate with each other and integrate data directly, without relying on the computer for intermediate data transmission. This greatly improves data transmission efficiency, reduces latency and errors caused by intermediate data transmission, and enhances the overall system performance and reliability.

Convenient dynamic configurations: Extension of data acquisition or communication reconfiguration can be completed on the computer, enabling dynamic configurations. Users can flexibly adjust the configurations of the networking system as needed, without the need of complicated hardware changes, and this greatly improves the usability and adaptability of the networking system.

### 4. High Integration of Operating Functions

The networking system integrates the functions of data acquisition, processing, and output in a single embedded data acquisition workstation through modular extension and reasonable structural layout. This kind of highly integrated design reduces dependence on external devices, simplifies the networking system and lowers the costs, and also improves stability, reliability, and facilitates maintenance and management.

### 5. Excellent Networking Performance

The present invention has strong networking capability to meet the needs in industrial scenarios of multiple levels, multiple protocols, dynamic configurations, and high flexibility. The present invention can flexibly construct networking schemes for various scenarios in metallurgy, nuclear power, pharmaceuticals, automation, environmental monitoring, modern agriculture, etc., achieving efficient and stable data acquisition, transmission, and processing, and thus providing strong support for intelligent and automated industrial productions.

Preferably, the networking system based on embedded data acquisition workstations of the present invention adopts a three-layer tree topology. Considering the ability of data penetration through layers and to avoid data transmission congestion that may affect data transmission efficiency or even data loss, said three-layer tree topology is preferred.

Preferably, a project file of each of the embedded data acquisition workstations 10 further comprises a customized interface. After configuring the customized interface, the customized interface and a native interface coexist, and the two interfaces can be switched by pressing a button or sliding up and down on a touchscreen. The customized interface not only enriches human-machine interaction interfaces, but also enables the displays of the embedded data acquisition workstation 10 to fit better with the application in use by flexibly configuring the customized interface on the embedded LINUX® operating system according to a particular application scenario, thereby improving the suitability of the customized interface of the embedded data acquisition workstation 10 with the particular application scenario, greatly improving the interface friendliness of the embedded data acquisition workstation 10, making its use more comfortable and convenient.

Preferably, the embedded LINUX® operating system of each of the embedded data acquisition workstations 10 has database software downloaded and installed. In addition to local storage by the local memory, the embedded LINUX® operating system also supports the installation of database software to connect to external hardware such as solid-state drives and SD cards. As such, not only can the data inside the embedded data acquisition workstation 10 be stored in the external hardware such as the solid-state drives and the SD cards to extend data storage, but also the data from external databases can be imported into the embedded data acquisition workstation 10 through said external hardware. The imported data not only contains historical data stored in the database of other devices, but can also be parameters supporting the customized interface and menu of the embedded data acquisition workstation 10, and may even be control strategies, PLC point tables, program codes, functions, recipes, etc. In this way, the flexibility and friendliness of the application of the embedded data acquisition workstation 10 are greatly improved.

Preferably, each of the embedded data acquisition workstations 10 of the present invention further comprises a screen backplane 3, a power board 4, a transmitter board 5, a digital input board 6, and an alarm board 7, and each of which is electrically connected to the core board 1; wherein the screen backplane 3, configured for screen control, is electrically connected to a display screen of the embedded data acquisition workstation 10; the power board 4 is configured to provide DC power to the core board 1, the acquisition board 2, the screen backplane 3, the power board 4, the transmitter board 5, the digital input board 6, and the alarm board 7; the transmitter board 5 is configured to output analog signals; the digital input board 6 is configured to input digital signals; the alarm board 7 is configured to control output of an alarm device. In addition to the screen backplane 3 and the power board 4, each embedded data acquisition workstation of the present invention further comprises the transmitter board 5, the digital input board 6, and the alarm board 7, wherein the transmitter board 5 is configured to output acquired values as analog signals, such as to other acquisition modules for remote synchronous display. Said other acquisition modules can be PLC, DCS acquisition systems, or other display devices; the digital input board 6 facilitates the acquisition of some status signals, such as whether external valves are open or closed, whether external devices are alarming, and whether external buttons are pressed; the alarm board 7 conveniently meets the need to trigger an alarm during monitoring of acquired data, for example, during water quality monitoring, when the monitored data reaches a preset value, an external alarm device can be connected via the alarm board 7 to trigger an alarm. By providing the transmitter board 5, the digital input board 6, and the alarm board 7, the functionality of the embedded data acquisition workstation 10 is greatly enriched, enabling the embedded data acquisition workstation 10 to meet more application requirements, and the functions of remote synchronous display with other acquisition modules, interlocking with external devices, and alarming function basically cover the needs of industrial productions, thus rendering the embedded data acquisition workstation 10 to have a wide range of functions and higher use value.

Preferably, each of the embedded data acquisition workstations of the present invention further comprises a common board 8. The acquisition board 2, the power board 4, the transmitter board 5, the digital input board 6, and the alarm board 7 are electrically connected to the core board 1 via the common board 8. The common board 8 serves as a bridge of connection between the core board 1 and the acquisition board 2, the power board 4, the transmitter board 5, the digital input board 6, and the alarm board 7, so that interfaces of the core board 1, the acquisition board 2, the power board 4, the transmitter board 5, the digital input board 6, and the alarm board 7 are all connected to the common board 8. Through the bridging function of the common board 8, the acquisition board 2, the power board 4, the transmitter board 5, the digital input board 6, and the alarm board 7 are electrically connected to the core board 1. The common board 8 facilitates a layout of installing the core board 1, the acquisition board 2, the screen backplane 3, the power board 4, the transmitter board 5, the digital input board 6, and the alarm board 7. The common board 8 is provided with interfaces connectible to the acquisition board 2, the power board 4, the transmitter board 5, the digital input board 6, and the alarm board 7. When the acquisition board 2, the power board 4, the transmitter board 5, the digital input board 6, and the alarm board 7 are connected to the common board 8 which is in turns connected to the core board 1, connections are made through corresponding interfaces.

Through the bridging function of the common board 8, interfaces of different boards such as the core board 1 and the acquisition board 2 are configured on the common board 8. The common board 8 provides spacious area for distribution of the interfaces so that it is adaptable to different distributions of the different boards in various positions. In other words, under the bridging function of the common board 8, the layout of different boards such as the core board 1 and the acquisition board can be greatly facilitated. For example, the different boards can be conveniently arranged vertically and distributed on two sides of the common board 8, which not only facilitates assembly, but also enables reasonable arrangement of external interfaces, so that the layout of the different boards inside the embedded data acquisition workstation and the positioning of the external interfaces are more reasonable.

Preferably, each of the embedded data acquisition workstations of the present invention further comprises a USB interface 31 and a TF (TransFlash) card slot 32, both electrically connected to the core board 1, and both soldered onto the screen backplane 3. The USB interface 31 is configured to connect an external USB drive for data export and transfer, and can also be multiplexed with an external keyboard and a mouse; after inserting a TF card into the TF card slot 32, the TF card expands the storage capacity of the data storage area. The USB interface 31 and the TF card slot 32 in the present invention enriches the functions of the embedded data acquisition workstation 10 in terms of data export, transfer, and extension of storage capacity, so that the embedded data acquisition workstation 10 can meet more application requirements. After the USB interface 31 and the TF card slot 32 are soldered onto the screen backplane 3, and the embedded data acquisition workstation is assembled as a meter device, it is convenient to externally expose the USB interface 31 and the TF card slot 32.

Preferably, each of the embedded data acquisition workstations of the present invention further comprises a SIM sub-board 41, a 4G board 42, a WIFI® board 43, an RS232 communication interface 44, an RS485 communication interface 45, an Ethernet interface 46, an Ethernet chip 33, an RS485 communication circuit 81, and a printer communication circuit 82. The SIM sub-board 41, the 4G board 42, the WIFI® board 43, the RS232 communication interface 44, the RS485 communication interface 45, and the Ethernet interface 46 are arranged on the power board 4. The Ethernet chip 33 is soldered onto the screen backplane 3. The RS485 communication circuit 81 and the printer communication circuit 82 are arranged on the common board 8. The SIM sub-board 41, the 4G board 42, and the core board 1 are electrically connected in sequence. The WIFI® board 43 is electrically connected to the core board 1. The RS232 communication interface 44, the printer communication circuit 82, and the core board 1 are electrically connected in sequence. The RS485 communication interface 45, the RS485 communication circuit 81, and the core board 1 are electrically connected in sequence. The Ethernet interface 46, the Ethernet chip 33, and the core board 1 are electrically connected in sequence. The SIM sub-board 41 is vertically soldered and fixed perpendicularly on the power board 4, and the SIM sub-board 41 comprises, but not limited to, a SIM card slot and a control circuit, and connects with the 4G board 42 via an I²C bus to exchange data. The 4G board 42 comprises, but not limited to, a 4G module and an external antenna. The 4G board 42 may be installed on the power board 4 in parallel with the power board 4 via, but not limited to, pin headers and sockets, and is connected to the core board 1 via USB serial bus through the common board 8. A function of the 4G board 42 is to realize wireless data transmission with computers and other peripherals via CDMA or GPRS wireless network of a SIM card. The WIFI® board 43 comprises, but not limited to, an onboard RTL8723 chip and its peripheral circuit, and can switch communication networks between WIFI® 2.4G and Bluetooth® 5.0; wherein, WIFI® uses SDIO interface, and Bluetooth® uses the USB serial bus; internally speaking, the WIFI® board 43 connects to the core board 1 via the common board 8 to transmit data, and externally speaking, the WIFI® board 43 connects with external devices via WIFI® 2.4G and Bluetooth® pairing. The RS232 communication interface 44 and the RS485 communication interface 45 are two other communication output interfaces, wherein the RS485 communication interface 45 can use a two-wire RS485 communication line to achieve networking with external devices, realizing network communication among multiple devices within a range of around one kilometer, and the protocol adopted can be a MODBUS-RTU standard protocol. The RS232 communication interface 44 is configured as an external micro-printer which receives parallel data to achieve scheduled or real-time printing of acquired data for users to review. The Ethernet chip 33 is configured to decode Ethernet communication data of the core board 1; the Ethernet chip 33 is but not limited to a RTL8211F PHY chip. The Ethernet interface 46 mainly comprises a HR911130 socket, which mainly comprises an RJ45 interface and an Ethernet transformer. During operation, the Ethernet communication data of the core board 1 is decoded into digital differential signals by the Ethernet chip 33 located on the screen backplane 3, and then the digital differential signals are transmitted to the Ethernet interface 46 on the power board 4 through the common board 8, and then being coupled by using the Ethernet transformer integrated in the Ethernet interface 46, and finally being transmitted to external network cables of different levels through the RJ45 interface integrated in the Ethernet interface 46. The embedded data acquisition workstations of the present invention supports various communication methods such as 4G, WIFI®, Bluetooth®, serial port, Ethernet, etc., to meet various communication needs of users, with better convenience in use. In the present invention, various chips and interfaces are arranged reasonably and connected conveniently. In addition, the RS485 communication circuit 81 and the printer communication circuit 82 are arranged on the common board 8, away from, for example, coils on the power board 4 such as high-frequency transformers, for reduced interference.

Preferably, the core board 1 comprises a core processor 11, a power management chip 12, and a memory unit 13; the power management chip 12 and the memory unit 13 are electrically connected to the core processor 11; the acquisition board 2 comprises an acquisition circuit 21, an acquisition processor 22, and an acquisition board memory 23; the acquisition circuit 21 and the acquisition board memory 23 are electrically connected to the acquisition processor 22; the power board 4 comprises an on/off power circuit 40 which is electrically connected to the power management chip 12; the transmitter board 5 comprises a transmitter output processor 51, an active low-pass filter circuit 52, an integrating circuit 53, and a transmitter board memory 54; the transmitter board memory 54 is electrically connected to the transmitter output processor 51; the transmitter output processor 51, the integrating circuit 53, and the active low-pass filter circuit 52 are electrically connected in sequence; the digital input board 6 comprises a digital acquisition processor 61 and a DI (Direct-Input) sampling circuit 62 electrically connected with each other; the alarm board 7 comprises an alarm processor 71 and an alarm control circuit 72 electrically connected with each other; the acquisition processor 22, the screen backplane 3, the transmitter output processor 51, the digital acquisition processor 61, and the alarm processor 71 are electrically connected to the core processor 11. The core processor 11 is, but not limited to, an ARM Cortex-A55 processor; the power management chip 12 is, but not limited to, an RK809 power management chip, and the memory unit 13 comprises, but not limited to, a DDR4 memory and an EMMC storage controller, wherein the DDR4 memory has a storage capacity of at least 2 GB and expandable up to 8 GB, and the EMMC storage controller comprises an 8 GB EMMC program storage area and an 8 GB EMMC data storage area. Additionally, SSD hard drives can be expanded via PCIe M.2 interfaces, and TF cards can be expanded via more of said TF card slot, thus further expanding a capacity of the data storage area. The acquisition board 2 and the core board 1 exchange data via a serial bus. The acquisition circuit 21 can acquire analog signals such as mA, mV, V, thermal resistance, and thermocouple, and a single acquisition board 2 can simultaneously acquire up to eight analog signals. According to user's requirements of different functions, more than one acquisition board can be provided. The acquisition board memory 23 is configured to store calibration values of sampled signals, and can be, for example, an I²C bus 24C04 memory. After the on/off power circuit 40 is electrically connected to the power management chip 12, the on/off power circuit 40 supplies power to various circuit boards via the power management chip 12. The transmitter board 5 and the core board 1 exchange data via a serial bus. The transmitter board 5 uses a PWM port of the transmitter output processor 51 to modulate its duty cycle to generate a pulse signal, which is sent to the active low-pass filter circuit 52 after being processed by the integrating circuit 53. At an output end of the active low-pass filter circuit 52, analog output signals that vary linearly with respect to a PWM duty cycle signal modulated by the transmitter output processor 51 are obtained. The analog output signals mainly comprise 0-20 mA, 4-20 mA, 0-5V, and 1-5V. The transmitter board memory 54 may be, for example, an I²C bus 24C04 memory connected to the transmitter output processor 51 for storing calibration parameters of transmitter output. The digital input board 6 and the core board 1 exchange data via a serial bus.

A single digital input board 6 can simultaneously acquire up to twelve channels of DI signals, and all DI acquisition is subject to isolation based on optoelectronic coupling to reduce interference. The alarm board 7 and the core board 1 exchange data via a serial bus. During operation, the alarm processor 71 controls the alarm control circuit 72 to send alarm signals through a PWM interface. At least twelve alarm control circuits can be configured on the alarm board 7 according to user's needs.

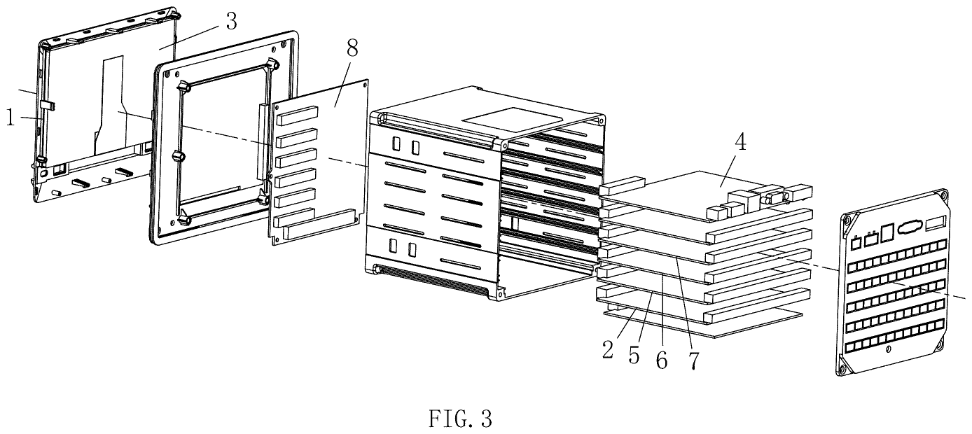

Preferably, as shown in FIG. 3, the core board 1 is mounted on the screen backplane 3; the common board 8 is arranged parallel and stacked with the screen backplane 3; the acquisition board 2, the power board 4, the transmitter board 5, the digital input board 6, and the alarm board 7 are all located on a side of the common board 8 away from the screen backplane 3; the acquisition board 2, the power board 4, the transmitter board 5, the digital input board 6, and the alarm board 7 are arranged in parallel and stacked with one another; the acquisition board 2 is oriented perpendicular to the common board 8. This structural arrangement not only facilitates assembly, but also facilitates external arrangement of different interfaces. For example, the USB interface 31 and the TF card slot 32 can be placed at one side of the screen backplane, while the SIM sub-board 41, the RS232 communication interface 44, the RS485 communication interface 45, and the Ethernet interface 46 can be placed at a rear part of the embedded data acquisition workstation away from the screen backplane.

The configuration software and the modular components contained in each of the embedded data acquisition workstations of the present invention are prior arts. For example, the configuration software may be but not limited to embedded versions or functionally similar software of commercial configuration platforms such as Siemens® SIMATIC WinCC, Rockwell® FactoryTalk View, AVEVA® InTouch HMI or Ignition. It is used to provide graphical human-machine interface (HMI) development, data acquisition and monitoring (SCADA), alarm management, and data logging functionalities. The common board may be but not limited to an ARM® Cortex-A53-based embedded development board running the LINUX® system, equipped with multiple GPIO, SPI, and I²C interfaces for connecting the core board with various functional boards (such as acquisition board and power board). The database software may be but not limited to MySQL Community Server 8.0 or SQLite 3.35, used for storing acquired data, alarm records, and user configuration information. The printer communication circuit may be but not limited to a CH340G chip-based implementation for USB-to-serial conversion, supporting the ESC/POS command set to drive external thermal printers (e.g., EPSON TM-T88V). The acquisition circuit may be but not limited to ADS1256 analog-to-digital converter chip, supporting 8-channel 24-bit high-precision acquisition and capable of processing analog signals such as mA, mV, V, thermocouples, and thermal resistance. The acquisition processor may be but not limited to STM32F103C8T6 microcontroller, connected to the ADS1256 via an SPI interface and responsible for signal acquisition and preprocessing. The on/off power circuit may be but not limited to an LM2596S buck converter module with an input voltage of 9-36V DC and an output of 5V/3 A, supplying power to the core board and various functional boards. The transmitter output processor may be but not limited to the STM32F030F4P6 microcontroller, generating 0-20 mA/4-20 mA analog signals via PWM output processed through an integrating circuit and low-pass filtering. The active low-pass filter circuit may be but not limited to a second-order Butterworth filter based on the OPA 217 operational amplifier, with a cutoff frequency of 100 Hz. The integrating circuit may be but not limited to an RC network with a time constant τ=10 ms, used to convert PWM signals into analog voltages. The digital acquisition processor may be but not limited to the STM32F051K8U6 microcontroller, supporting 12 channels of optoelectronically isolated DI inputs for acquiring on/off status signals. The DI sampling circuit may be but not limited to TLP281-4 optocoupler isolation chip, with an input voltage range of 5-24V DC, supporting both dry contact and wet contact signal inputs. The alarm processor may be but not limited to STM32F031G6U6 microcontroller, controlling alarm relays or buzzers via PWM outputs. The alarm control circuit may be but not limited to a ULN2003 Darlington array for driving relays, with a maximum load current of 500 mA and supporting 12 channels of alarm outputs.

To those skilled in the art, various simple modifications or substitutions can be made without departing from the inventive concept of the present invention, and all such modifications or substitutions should be considered within the protection scope of the present invention.

1. A networking system based on embedded data acquisition workstations, comprising a plurality of said embedded data acquisition workstations and a computer, wherein each of the embedded data acquisition workstations comprises a core board, an acquisition board, and a common board; both the core board and the acquisition board interface with the common board; the common board is a networking bridge between the core board and the acquisition board; the acquisition board is electrically connected with the core board via the common board; the core board adopts an embedded LINUX® operating system; at least one of said embedded data acquisition workstations serves simultaneously as both a master station and a slave station; the networking system has a tree topology with at least three layers, where a root node of the tree topology is the computer, and all other nodes of the tree topology apart from the root node are the embedded data acquisition workstations; the embedded LINUX® operating system of each of the embedded data acquisition workstations is installed with a configuration software; a project file executable by the configuration software is imported into each of the embedded data acquisition workstations; the embedded data acquisition workstations form at least one parent-child node relationship wherein the project file of a parent node is written with communication protocols of corresponding child nodes thereof.

2. The networking system based on embedded data acquisition workstations as claimed in claim 1, wherein the networking system based on embedded data acquisition workstations adopts a three-layer tree topology.

3. The networking system based on embedded data acquisition workstations as claimed in claim 1, wherein the project file of each of the embedded data acquisition workstations further comprises a customized interface.

4. The networking system based on embedded data acquisition workstations as claimed in claim 1, wherein the embedded LINUX® operating system of each of the embedded data acquisition workstations has database software downloaded and installed.

5. The networking system based on embedded data acquisition workstations as claimed in claim 1, wherein each of the embedded data acquisition workstations of the present invention further comprises a screen backplane, a power board, a transmitter board, a digital input board, and an alarm board, and each of which is electrically connected to the core board.

6. The networking system based on embedded data acquisition workstations as claimed in claim 5, wherein the power board, the transmitter board, the digital input board, and the alarm board are electrically connected to the core board via the common board.

7. The networking system based on embedded data acquisition workstations as claimed in claim 5, wherein each of the embedded data acquisition workstations of the present invention further comprises a USB interface and a TransFlash (TF) card slot, both electrically connected to the core board, and both soldered onto the screen backplane.

8. The networking system based on embedded data acquisition workstations as claimed in claim 5, wherein each of the embedded data acquisition workstations of the present invention further comprises a SIM sub-board, a 4G board, a WIFI® board, an RS232 communication interface, an RS485 communication interface, an Ethernet interface, an Ethernet chip, an RS485 communication circuit, and a printer communication circuit; the SIM sub-board, the 4G board, the WIFI® board, the RS232 communication interface, the RS485 communication interface, and the Ethernet interface are arranged on the power board; the Ethernet chip is soldered onto the screen backplane; the RS485 communication circuit and the printer communication circuit are arranged on the common board; the SIM sub-board, the 4G board, and the core board are electrically connected in sequence; the WIFI® board is electrically connected to the core board; the RS232 communication interface, the printer communication circuit, and the core board are electrically connected in sequence; the RS485 communication interface, the RS485 communication circuit, and the core board are electrically connected in sequence; the Ethernet interface, the Ethernet chip, and the core board are electrically connected in sequence.

9. The networking system based on embedded data acquisition workstations as claimed in claim 5, wherein the core board comprises a core processor, a power management chip, and a memory unit; the power management chip and the memory unit are electrically connected to the core processor; the acquisition board comprises an acquisition circuit, an acquisition processor, and an acquisition board memory; the acquisition circuit and the acquisition board memory are electrically connected to the acquisition processor; the power board comprises an on/off power circuit which is electrically connected to the power management chip; the transmitter board comprises a transmitter output processor, an active low-pass filter circuit, an integrating circuit, and a transmitter board memory; the transmitter board memory is electrically connected to the transmitter output processor; the transmitter output processor, the integrating circuit, and the active low-pass filter circuit are electrically connected in sequence; the digital input board comprises a digital acquisition processor and a Direct-Input (DI) sampling circuit electrically connected with each other; the alarm board comprises an alarm processor and an alarm control circuit electrically connected with each other; the acquisition processor, the screen backplane, the transmitter output processor, the digital acquisition processor, and the alarm processor are electrically connected to the core processor.

10. The networking system based on embedded data acquisition workstations as claimed in claim 6, wherein the core board is mounted on the screen backplane; the common board is arranged parallel and stacked with the screen backplane; the acquisition board, the power board, the transmitter board, the digital input board, and the alarm board are all located on a side of the common board away from the screen backplane; the acquisition board, the power board, the transmitter board, the digital input board, and the alarm board are arranged in parallel and stacked with one another; the acquisition board is oriented perpendicular to the common board.
